(19) United States
(12) Patent Application Publication
(10) Pub. No.: US 2011/0058189 A1
(43) Pub. Date: Mar. 10, 2011

(54) INFORMATION PROCESSING APPARATUS, INFORMATION PROCESSING SYSTEM, IMAGE FORMING APPARATUS, AND INFORMATION PROCESSING METHOD

(75) Inventor: Michio KUWAMURA, Tokyo (JP)

(73) Assignee: FUJI XEROX CO., LTD., Tokyo (JP)

(21) Appl. No.: 12/712,309

(22) Filed: Feb. 25, 2010

(30) Foreign Application Priority Data
Sep. 9, 2009 (JP) 2009-208561

(51) Int. Cl. G06K 15/02; G10L 21/00

(52) U.S. Cl. 358/1.9; 704/270; 704/E21.001

(57) ABSTRACT

According to an aspect of the invention, an information processing apparatus includes a process instruction receiving module, a storage module, and a process state output module. The storage module receives a process instruction from a user. The storage module stores the process instruction and language attribute information to associate with each other, the language attribute information designating a language for outputting a process state of the process instruction. The process state output module outputs information of the process state in the language designated by the language attribute information associated with the process instruction.

### CROSS-REFERENCE TO RELATED APPLICATIONS

This application is based upon and claims priority under 35 USC 119 from Japanese Patent Application No. 2009-208561, filed Sep. 9, 2009.

### BACKGROUND

### Technical Field

The present invention relates to an information processing apparatus, an information processing system, an image forming apparatus, and an information processing method.

### SUMMARY OF THE INVENTION

According to an aspect of the invention, an information processing apparatus includes a process instruction receiving module, a storage module, and a process state output module. The storage module receives a process instruction from a user. The storage module stores the process instruction and language attribute information to associate with each other, the language attribute information designating a language for outputting a process state of the process instruction. The process state output module outputs information of the process state in the language designated by the language attribute information associated with the process instruction.

### BRIEF DESCRIPTION OF THE DRAWINGS

Exemplary embodiments of the invention will be described in detail based on the following figures, wherein:

FIG. 1 is a diagram illustrating an example of an image forming apparatus as an example of an information processing apparatus to which a control according to an exemplary embodiment is applied;

FIG. 2 is a schematic diagram illustrating an example of a data structure of job queue information;

FIG. 3 is a diagram illustrating an example of a job state display screen;

FIG. 4 is a flowchart illustrating an example of a registration sequence of a language attribute on a job;

FIG. 5 is a flowchart illustrating an example of a sequence of job state outputs;

FIG. 6 is a flowchart illustrating an example of sequence of job state screen displays; and

FIG. 7 is a flowchart illustrating an example of a sequence of job state sound outputs.

### DETAILED DESCRIPTION

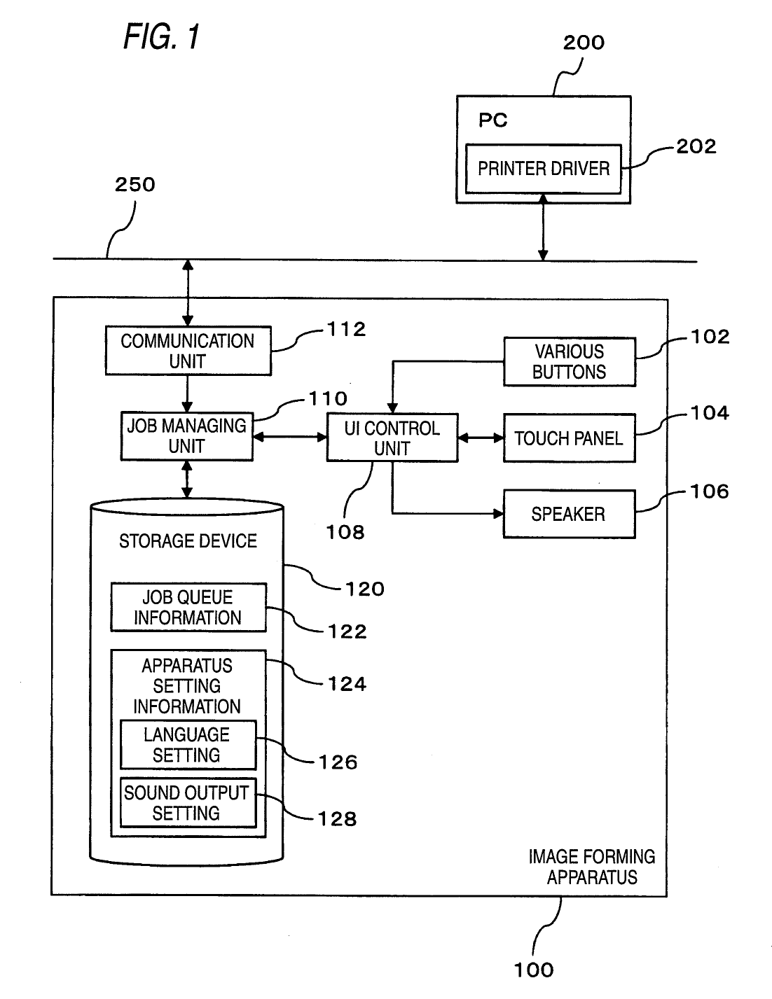

FIG. 1 shows an example of a system including an image forming apparatus as an example of an information processing apparatus to which a control method according to an exemplary embodiment is applied.

An image forming apparatus 100 is an apparatus performing a process with input or output of a document image, for example, at least one of, for example, image reading or copying of paper documents, printing of electronic documents (documents represented by electronic data), and transmission or reception of facsimiles. For example, there are a digital copier, a digital multifunctional machine (an apparatus provided with functions of a printer, a scanner, a copier, and the like, and an apparatus further provided with an additional function such as facsimile transmission/reception), a network printer, a network scanner, a facsimile apparatus, and the like.

Various buttons 102 of the image forming apparatus 100 are mechanical buttons for inputting instructions of a user to the image forming apparatus 100. For example, there are a start button for instructing start of a process such as copy, and a ten key numeric keypad for inputting numerical values such as the number of printings. A touch panel 104 is an input/output device provided with a display device such as a liquid crystal screen and a position detecting mechanism detecting a touch position of a user's finger on the screen. A speaker 106 is a device for outputting sound such as alarm and audio guidance (guidance).

A UI (user interface) control unit 108 is means for performing a user interface process of the image forming apparatus 100. For example, the UI control unit 108 displays an operation screen or a screen representing various kinds of information on the touch panel 104, or outputs an alarm when an error occurs or guidance sound in an audio guidance (guidance) mode to the speaker 106. The UI control unit 108 determines contents input by the user from a touch position of a user's finger with respect to the touch panel 104, and transmits the input contents to a job managing unit 110. The UI control unit 108 transmits the input contents from the various buttons 102 to the job managing unit 110.

The job managing unit 110 generates and manages jobs according to the input contents of the user received from the UI control unit 108. The job is a 1-unit process performed according to the instruction from the user by the image forming apparatus 100, for example, a copy job, a printing job, a scan job, a facsimile transmission job, and the like. For example, when the user operates the various buttons 102, the touch panel 104, or the like to input a type of a job or parameters (e.g., the number of copies or designation of both sides/one side, etc.) and presses the start button, the type of the job is performed according to the parameters. When the job managing unit 110 receives printing instruction data, which is transmitted from a remote PC (personal computer) 200 through a network such as a local area network, through a communication unit 112, a printing job for printing the printing instruction data is generated and managed.

The job managing unit 110 puts the jobs into a waiting queue (job queue) in order of generation, and manages the jobs in first-in first-out order.

A storage device 120 is a rewritable storage device of an information processing unit of the image forming apparatus 100. The storage device 120 includes any one of a volatile recording medium such as a RAM (Random Access Memory), a nonvolatile recording medium such as an EEPROM (Electrically Erasable Programmable ROM), a flash memory, and a hard disk, and the like, or combination of 2 or more of them. In addition, the image forming apparatus 100 may be provided with the other storage devices such as a ROM (Read Only Memory).

Apparatus setting information 124 regulating operation parameters of the image forming apparatus 100 is stored in the storage device 120.

The apparatus setting information 124 includes a language setting 126 designating a language used in UI (e.g., various screens displayed on the touch panel 104 or audio guidance output from the speaker 106) of the image forming apparatus 100. That is, the image forming apparatus 100 is an apparatus corresponding to a plurality of languages, and a language selected by the user is stored in the language setting 126. The UI control unit 108 provides a UI screen or the like with the language corresponding to the language setting 126.

The apparatus setting information 124 may include a sound output setting 128. The sound output setting 128 is setting information representing whether or not audio guidance by the speaker 106 is performed. This setting may be modified by the user.

Various setting items such as the language setting 126 and the sound output setting 128 of the apparatus setting information 124 are set or modified by the user through the UI screen for setting. The screen for setting is provided by the UI control unit 108. For example, when the language displayed on the touch panel 104 is different from the language that the user uses, the user calls the UI screen for setting by selecting a menu on the touch panel 104 and modifies the language into the language that the user uses.

Alternatively, user authentication may be performed when the user uses the image forming apparatus 100, and a setting corresponding to the user identified by the user authentication may be reflected to the language setting 126, the sound output setting 128, or both. The user authentication may be performed, for example, by a authentication method such as reading an IC identification card or inputting a password. The setting contents (kind of language used and whether sound output is necessary or not) corresponding to each user may be registered in the image forming apparatus 100 so as to be associated with identification information of the user, for example. Alternatively, the language corresponding to the user identification information or the setting contents of the sound output is registered in an external apparatus accessible from the image forming apparatus 100 (e.g., through a network such as a local area network), and the image forming apparatus 100 may acquire the setting contents corresponding to the user from the external apparatus.

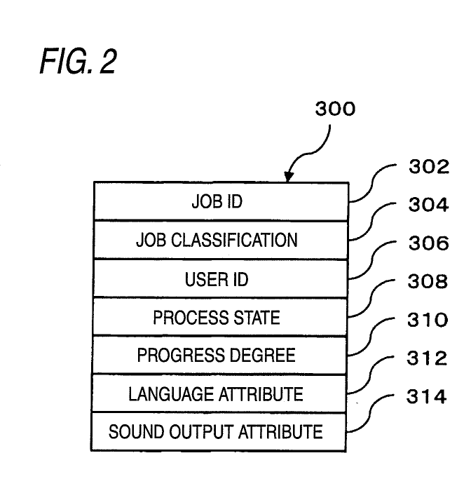

Job queue information 122 that is information of a waiting queue used for the job managing unit 110 to manage job execution is stored in the storage device 120. FIG. 2 shows an example of a data structure of management information of a job included in the job queue information 122. As shown in FIG. 2, management information 300 of one job includes a job ID 302 that is identification information of the job. The job ID 302 may be assigned when the job managing unit 110 generates management information of the job according to the instruction of the user. The management information 300 includes job classification 304 representing classification (printing, copy, scan, facsimile transmission, etc.) of the job. The management information 300 may include a user ID 306 that is identification information of the user who instructs the job to be executed. The value of the user ID 306 may be specified, for example, by reading the IC identification card of the user or performing the user authentication on the basis of the input of authentication information such as a user ID and a password. A printer driver 202 installed in the PC 200 incorporates the user ID of the user who is logged into the PC 200 into the printing instruction data input from the remote PC 200, and the job managing unit 110 may recognize the user ID. In addition, the management information 300 may include the other information at the time when the execution of the job is instructed.

A process state 308 included in the management information 300 is information representing a present process state of the job. As the process state 308, for example, there are “process waiting” of waiting for sequence in the queue, “executing” representing that the job is being executed, “pause” representing that the execution is temporarily paused by interruption or the like, and “error” representing that an error occurs. A progress degree 310 is information representing a progress degree of the execution of the job, for example, a value representing that the process is completed up to any page of the total number of pages. The process state 308 and the progress degree 310 are dynamically changed as the image forming apparatus 100 manages and executes the job.

In addition, the management information 300 of the job includes a language attribute 312 of the job. That is, in the exemplary embodiment, the language attribute 312 is registered by a job unit in addition to the language setting 126 regarding the image forming apparatus 100. The language attribute 312 is set on the basis of an instruction from the user who inputs the job or a setting of the image forming apparatus 100 at the time of the instruction is input. For example, when a user who inputs a job uses English, the language attribute 312 of the job is set to English. The UI control unit 108 controls the UI to display the information about the job in English, without depending on the language setting 126 of the apparatus setting information 124.

The management information 300 of the job includes a sound output attribute 314 of the job. This represents whether or not the information about the job is output by sound. That is, in the exemplary embodiment, it is set whether or not audio guidance is performed by a job unit with respect to the output of the audio guidance, independently from the sound output setting 128 of the apparatus setting information 124. The sound output attribute 314 of the job unit is set on the basis of an instruction from the user who inputs the job or a setting of the image forming apparatus at the time of the instruction is input.

In addition, the image forming apparatus 100 is provided with a scan mechanism, a printing mechanism, a facsimile mechanism, and the like to execute various jobs, but they are not shown.

When the user operating the PC 200 instructs printing of a document drawn by an application such as a word processor, the printer driver 202 converts data of the document into printing instruction data described by page describing language, and transmits the data to the image forming apparatus 100.

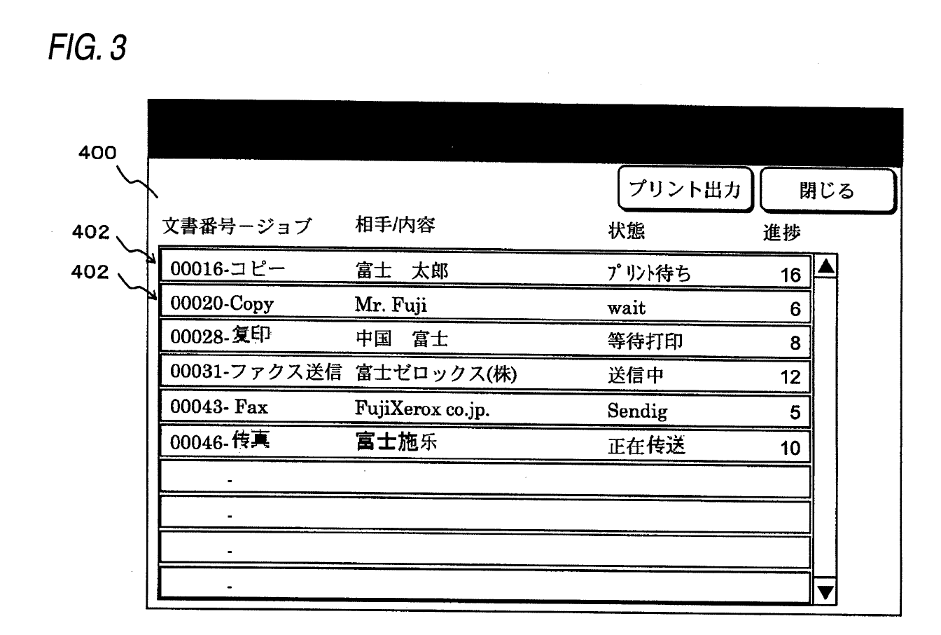

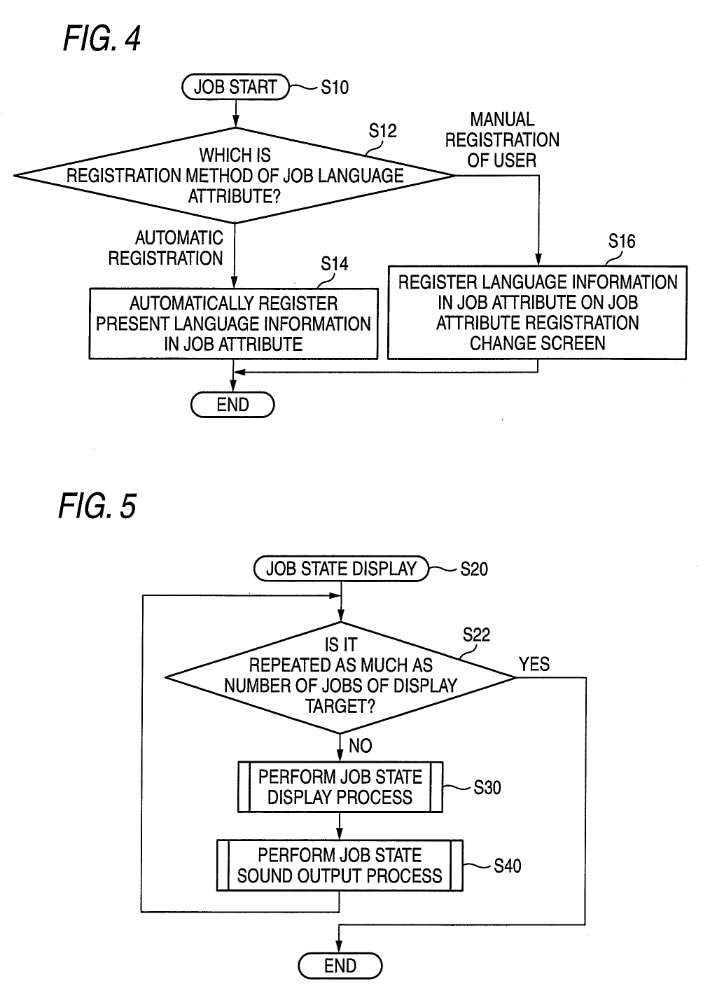

In such a system, the UI control unit 108 of the image forming apparatus 100 has a function of displaying the process state in the language according to the language attribute 312 of the job at the time of displaying the list of the process states of the jobs in the job queue (e.g., process waiting or executing). In an example of a list display screen 400 shown in FIG. 3, in job state display sections 402 for displaying the process states of the jobs, information (e.g., items of the management information 300) of the jobs is displayed such that the job of the document number (job ID) “00016” is displayed in Japanese, the job of the document number “00020” is displayed in English, and the job of the document number “00028” is displayed in Chinese.

Next, an example of a process sequence of the image forming apparatus 100 will be described. First, an example of a registration process of the language attribute 312 of the job performed by the job managing unit 110 will be described. As a background of the process, the image forming apparatus 100 has two methods of automatic registration and manual registration as a registration method of the language attribute 312 of the job unit, for example, a manager sets the method to be used, to the image forming apparatus 100. When the user presses the start button of the image forming apparatus 100 to start generating a job (S10), the job managing unit 110 determines whether the setting value of the registration method is automatic or manual (S12). When the registration method is automatic, the value of the language setting 126 of the present apparatus setting information 124 is registered in the item of the language attribute 312 of the generated job (S14). That is, when the user inputs a type of the job or parameters, it is thought that the language of the screen displayed on the touch panel 104 or of the audio guidance is generally set to the language which the user uses. Accordingly, the value of the language setting 126 representing the setting is registered as the language attribute 312 of the job. In Step S12, when it is determined that the registration method is the manual registration, the job managing unit 110 displays a job attribute registration change screen on the touch panel 104 through the UI control unit 108, receives the relevant designation of the language from the user, and registers the designated language as the language attribute 312 of the job (S16).

The registration sequence of the language attribute 312 of the job has been described above, and the same may be applied to the sound output attribute 314. That is, when the automatic registration is selected as the registration method, the value of the sound output setting 128 of the apparatus setting information 124 at the job starting time is registered in the sound output attribute 314 of the job. When the manual registration is selected, the designation regarding the sound output which is input to the job attribute registration change screen by the user may be registered in the sound output attribute 314 of the job.

The setting sequence of the language attribute 312 about the job generated by allowing the user to directly input the instruction to the UI of the image forming apparatus 100 has been described above. Meanwhile, the language attribute 312 of the job may be set to the job generated according to the instruction (e.g., printing instruction) input from the external apparatus such as the PC 200 to the image forming apparatus 100. In this case, the program (e.g., printer driver 202) in the PC 200 acquires the setting of the language used in the operating system or the printer driver 202 of the PC 200, and the language setting may be incorporated as the language attribute in the instruction data for the image forming apparatus 100. The job managing unit 110 of the image forming apparatus 100 sets the language attribute included in the instruction data output from the external apparatus, as the language attribute 312 of the job corresponding to the instruction data. Similarly, in the case of the sound output attribute 314, the sound output setting of the external apparatus is incorporated as the attribute into the instruction data transmitted to the image forming apparatus 100 by the external apparatus such as the PC 200, and the job managing unit 110 of the image forming apparatus 100 may set the attribute as the sound output attribute 314 of the job.

Next, an example of the process sequence of the UI control unit 108 at the time of outputting information of the job state will be described with reference to FIG. 5 to FIG. 7. In this sequence, when the user instructs display of the job state from, for example, the touch panel 104 or the like (S20), a job state screen display process (S30) and a job state sound output process (S40) are performed on a job, state information of which is not yet output. The processes are repeated until the output process of the state information is completed for all the jobs (e.g., non-processed job, job under processing, and job interrupted by error or the like) of display targets in the job queue information 122 (S22).

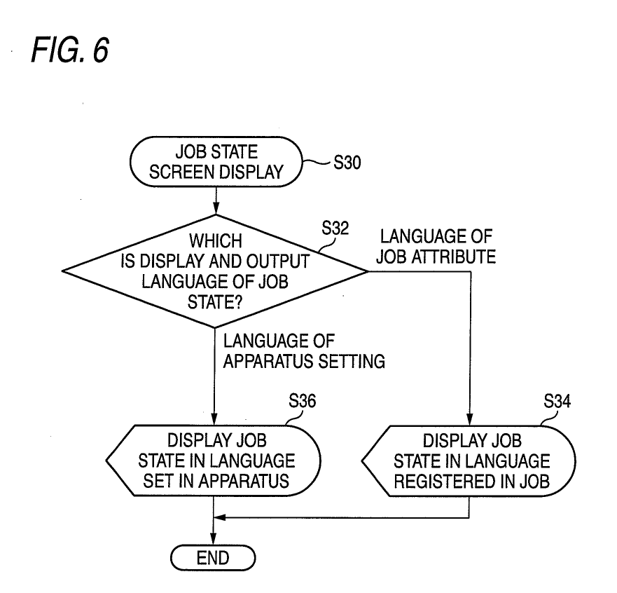

In the job state screen display process (S30), as shown in FIG. 6, the UI control unit 108 determines whether the language for displaying and outputting the job state set in the image forming apparatus 100 is the language designated in the language attribute 312 (language of job attribute) of the job or the language designated in the language setting 126 (language of the apparatus setting) of the apparatus setting information 124 (S32). That is, in this example, a manager or the like sets in advance whether language designated in the language attribute 312 is used or language designated in the language setting 126 is used, in the image forming apparatus 100. In Step S32, when the setting represents the language designated in the language attribute 312, the UI control unit 108 displays information (e.g., job ID, user information, process state, progress degree, etc. of the management information 300) of the process state of the display target job as a list on the display screen in the language designated in the language attribute 312 of the job (S34). In this case, the list display screen of the job state shown in FIG. 3 by way of example is obtained. In Step S32, when the setting represents the language designated in the language setting 126, the UI control unit 108 displays information of the process state of the display target job as a list on the display screen in the language designated in the language setting 126 (S36).

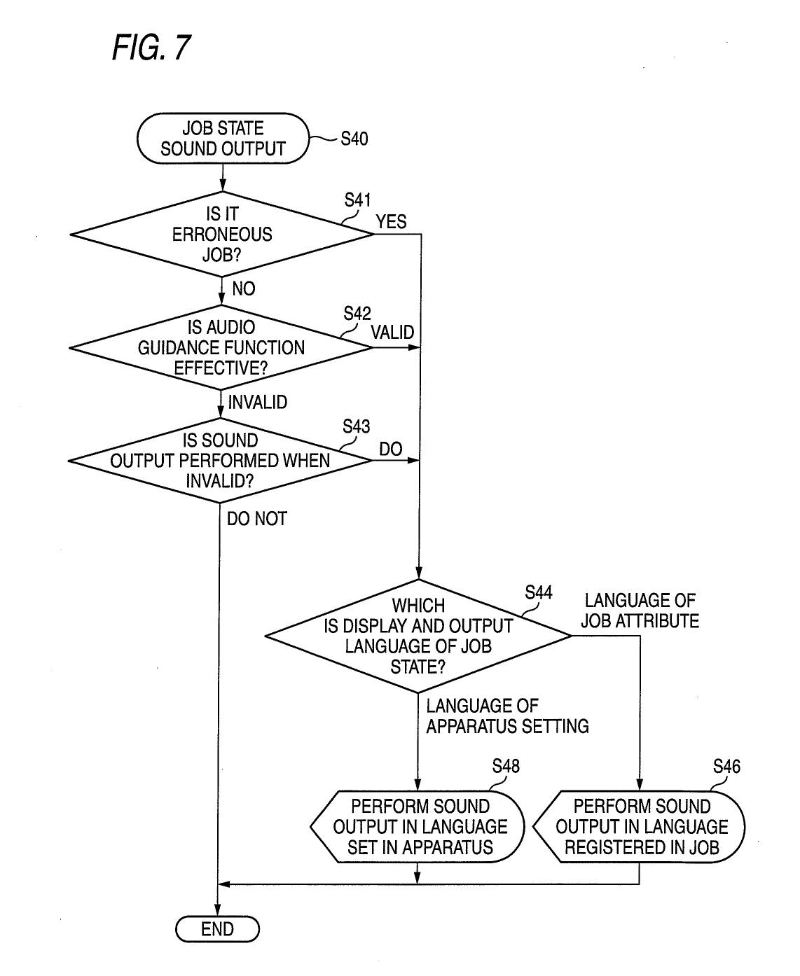

In the job state sound output process (S40), the UI control unit 108 performs, for example, the process shown in FIG. 7. That is, in this process, first, when any one of the following jobs is satisfied: the job that is the target of the state output process is an error job (S41), the sound output setting 128 of the apparatus setting information 124 is set as “valid” (sound output is performed) (S42), or the sound output attribute 314 of the job is set as “valid” (sound output is performed) even when the sound output setting 128 is “invalid” (S43), the information of the process state of the job is output from the speaker 106 by sound. In this case, the UI control unit 108 determines whether the language for displaying and outputting the job state set in the image forming apparatus 100 is the language designated in the language attribute 312 (language of job attribute) or the language designated in the language setting 126 (language of the apparatus setting) (S44). In the case of the former, the information of the process state of the job is output in the language designated in the language attribute 312 of the job by sound (S46). In the case of the latter, the information of the process state of the job is output in the language designated in the language setting 126 of the apparatus setting information 124 by sound (S48).

When the target job is not in the error state (S41), the sound output setting 128 of the apparatus setting information 124 is “invalid” (S42), and when the sound output attribute 314 of the job represents that the sound output is not performed, the sound output of the process state is not performed on the job.

As described above, in the job state sound output process (S40), even when the sound output setting 128 of the image forming apparatus 100 is invalid, the process state of the job is output by sound when the sound output attribute 314 of the individual job designates the sound output. In this example, even when both the sound output setting 128 of the apparatus setting information 124 and the sound output attribute 314 of the job are set so as not to perform the sound output, when the job is erroneous, the audio guidance representing that the job is erroneous is output to prevent oversight of notification of the error, for example, on the list display screen.

The example of the list display of the process state of the job or the sound output has been described above, but the language switching in the job unit in the exemplary embodiment may be applied at the time when the other information regarding the job is suggested. For example, as for the job in the state of waiting for the process or processing in the job queue, there is an image forming apparatus having a function of receiving a change instruction of the process parameters. In such an apparatus, for example, when the user selects one job by touching the list display screen of the job state displayed on the touch panel 104, the change screen of the parameters of the job is displayed. The language of the menu or the guide message displayed on the change screen may be considered as the language represented by the language attribute 312 of the job.

When the user completes the change operation on the change screen and the screen displayed on the touch panel 104 returns to the list display screen, in one example, the returning list display screen is displayed in the language of the language attribute 312 of the job corresponding to the job state display sections 402 in the same manner as the original list display screen (see FIG. 3). The common parts (indexes of items of job state information, operation buttons such as “print output”, etc.) which do not depend on the job except for the job state display sections 402 may be displayed in the language of the language setting 126 of the apparatus setting information 124. In another example, the returning list display screen may be displayed in the language represented by the language attribute 312 of the job selected by the user. In this example, only the common parts except for the job state display sections 402 on the returning list display screen may be displayed in the language represented by the language attribute 312 of the job selected by the user, and the job state display sections 402 may be also displayed in the language of the language attribute 312 of the job as well as the job state display sections 402. When the display language of the common parts of the returning list display screen as described above is changed into the language (i.e., the language corresponding to the job selected by the user) different from that of the language setting 126 of the apparatus setting information 124, a button for returning the display language to the language of the apparatus is displayed on the list display screen. When the button is pressed, the UI control unit 108 may return the display language of the list display screen to the language of the language setting 126. Instead of the button provided to return the language as a software button on the list display screen on the touch panel 104 as described above, or in addition thereto, when a predetermined button (e.g., a clear button) of the hardware keys of the image forming apparatus 100 is pressed, the display language of the list display screen may be returned to the language of the language setting 126. Instead of such a button, or in addition thereto, the display language of the list display screen may be controlled to be automatically returned to the language of the language setting 126 when a predetermined time elapses from the time when the display language of the common parts of the list display screen is changed to the language different from that of the language setting 126 of the apparatus setting information 124.

The control of the display language of the change screen for receiving the change instruction of the process parameters or the execution sequence with respect to the job selected on the list display screen has been described above, but the display language of the screen representing a different kind of information with respect to the job selected on the list display screen can also be controlled in the same manner. For example, there is a detail screen for displaying detail information (information, the entirety of which cannot be displayed on the state display sections 402 of the list display screen) of the process state of the selected job, or a screen for deleting the selected job or changing the execution sequence (priority of execution).

When the user selects a job on the list display screen 400 (see FIG. 3), the display language of the whole list display screen 400 or a part (common parts which do not depend on the individual job) of the list display screen 400 except for the job state display sections 402 may be switched to the language of the language attribute 312 of the selected job.

The audio guidance may be output from the speaker 106 to instruct the change of process conditions of such a job, and the language of the sound output may be the language represented by the language attribute 312 of the job. For example, when the user performs the user authentication using the IC identification card with respect to the image forming apparatus 100, the process-waiting or processing job of the user remains in the job queue, and the sound output attribute 314 of the job represents that the sound output is to be performed, the audio guidance for the process condition change operation with respect to the processing job is performed in the language of the language attribute 312 of the job.

In addition to displaying the process state of the job on the display screen such as the touch panel 104 associated with the image forming apparatus 100, for example, the process state of the job may be printed out as a report, or may be transmitted to a remote device such as the PC 200 and a server managing the image forming apparatus 100 to display the process state on the remote device. In the latter case, there is a case where only the data of the process state of the job is transmitted, and there is a case where information (e.g., a web page) representing the display screen displaying the process state of the job is transmitted. As described above, when the image forming apparatus 100 prints out the information of the process state of the job or transmits the information to the other apparatus or when the image forming apparatus 100 transmits the information representing the screen displaying the process state of the job, the language for displaying the process state of the job or the display language of the screen for the display thereof may be controlled to be the language represented by the language attribute 312 of the job.

The part taking charge of the function of the operation process of the image forming apparatus 100 and the PC 200 exemplified above are realized, for example, by causing a general-purpose computer to execute a program representing the processes of the functional modules. For example, the computer has a circuit configuration in which a microprocessor such as a CPU, a memory (first memory) such as a random access memory (RAM) and a read only memory (ROM), a HDD controller controlling a HDD (Hard Disk Drive), various I/O (Input/Output) interfaces, a network interface performing a control for access to a network such as a local area network, and the like, as hardware, are connected through, for example, a bus. The bus may be connected to a disk drive for reading and/or writing on a portable disk recording medium such as a CD and a DVD, a memory reader/writer for reading and/or writing on a portable nonvolatile recording medium based on various standards such as a flash memory, and the like through, for example, the I/O interface. The program describing the whole process contents of the functional modules exemplified above is stored in a fixed storage device such as the hard disk drive and is installed in the computer through the recording medium such as the CD or DVD or through communication means such as the network. The program stored in the fixed storage device is read out to the RAM and is executed by the microprocessor such as the CPU, thereby realizing the functional module group exemplified above. A part or the whole of the functional module group may be configured as a hardware circuit such as a dedicated LSI (Large Scale Integration), an ASIC (Application Specific Integrated Circuit, on-demand integrated circuit for specific use), and a FPGA (Field Programmable Gate Array).

In the above described examples, the case where the image forming apparatus 100 is provided with the job managing unit 110 and the image forming apparatus 100 performs the execution management of the job has been described, but the application of the control of the display language or the sound output in the exemplary embodiment is not limited to such a case. For example, even when the print server connected to the image forming apparatus 100 through a network 250 or a communication cable performs the management of the job to be executed by the image forming apparatus 100, the control of the exemplary embodiment can be applied. In this case, the screen related to the job such as the list display screen of the process state of the job to be executed by the image forming apparatus 100 may be displayed on the display device to be associated with the print server, and the image forming apparatus 100 receives the information of the process states of the jobs or the information of the screen related to the job from the print server to display it. The display language of the screen display related to the job such as the list display screen in the printer server or the image forming apparatus 100 may be controlled according to the language attribute 312 of the job by the control of the exemplary embodiment. In this case, the print server has the function of the job managing unit 110 and stores the language attribute 312 of the jobs (of course, the print server may store the job queue information 122), and the process state or the display language of the screen related to various jobs such as the list display screen may be controlled to be switched in the same manner as the exemplary embodiment. Even when the report of the process state of the job is printed out from the image forming apparatus 100, the print server may create data of the report representing the process state in the language of the language attribute 312 of the job and may transmit the data to the image forming apparatus 100 to print the data. The print server may store the sound output attribute 314 of the jobs, and it may be controlled according to the sound output attribute 314 whether or not the guidance sound is output for the job selected by the user with respect to the print server or the image forming apparatus 100. The language of the guidance sound may be controlled according to the language attribute 312 of the job stored in the print server.

In the examples, the case where the user interface screen such as the list display screen of the process states of the jobs, the detail display screen of the job process state, and the change screen of the process parameters, the execution sequence, or the like is displayed on the display device such as the touch panel 104 of the image forming apparatus 100 has been described, but this case is no more than an example. Alternatively, or in addition thereto, such a user interface screen may be displayed on a remote device such as the PC 200. The instruction input from the user to such a user interface screen may be received by the remote device and may be reported to the image forming apparatus 100 (or the print server managing it). The display language of the screen display in such a remote device may be controlled to be switched in the same manner as the exemplary embodiment. In this case, the job managing unit 110 of the image forming apparatus 100 (or the print server managing it) may, when the screen information representing the user interface screen such as the list display screen is generated, generate the screen information displayed in the language of the language attribute 312 of the job with the information (process state), or the screen, related to the job, and may provide screen information to the remote device.

The image forming apparatus 100 has been described above by way of example, but the configuration and the method of the exemplary embodiment are not limited to the image forming apparatus, and can be applied to an information processing apparatus which receives and performs the process instruction and outputs the process state of the instructed process. Particularly, it is conceivable to apply them to an information processing apparatus receiving process instructions from a plurality of users.

The foregoing description of the exemplary embodiment of the present invention has been provided for the purpose of illustration and description. It is not intended to be exhaustive or to limit the invention to the precise forms disclosed. Obviously, many modifications and various will be apparent to practitioners skilled in the art. The embodiments were chosen and described in order to best explain the principles of the invention and its practical application, thereby enabling other skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a process instruction receiving module that receives a process instruction from a user;
a storage module that stores the process instruction and language attribute information to associate with each other, the language attribute information designating a language for outputting a process state of the process instruction; and
a process state output module that outputs information of the process state in the language designated by the language attribute information associated with the process instruction.

2. The information processing apparatus according to claim 1, further comprising a screen generating module that generates a list screen for displaying the process instruction stored in the storage module and that generates a second screen for displaying information with respect to the process instruction selected by the user from the list screen,
wherein the screen generating module generates the second screen by using the language designated by the language attribute information corresponding to the selected process instruction.

3. The information processing apparatus according to claim 2, wherein the storage module further stores a second process instruction and second language attribute information to associate with each other, the second language attribute information designating a second language for outputting a second process state of the second process instruction,
after the screen generating module generates the second screen, as a screen to be displayed instead of the second screen, the screen generating module generates a second list screen displaying the process instruction in the language, the second process instruction in the second language, and elements other than the process instruction and the second process instruction in the language designated by the language attribute information corresponding to the selected process instruction.

4. The information processing apparatus according to claim 2, wherein the storage module further stores a second process instruction and second language attribute information so as to associate the second process instruction with the second language attribute information, the second language attribute information designating a second language for outputting a second process state of the second process instruction,
after the screen generating module generates the second screen, as a screen to be displayed instead of the second screen, the screen generating module generates a second list screen displaying the process instruction, the second process instruction, and elements other than the process instruction and the second process instruction in the language designated by the language attribute information corresponding to the selected process instruction.

5. The information processing apparatus according to claim 1 further comprising a language designation receiving module that receives a language designation for designating a language used by a user when the process instruction receiving module receives the process instruction from the user,
wherein the storage module stores the language designation as the language attribute information to associate the process instruction with the language designation when the process instruction receiving module receives the process instruction.

6. The information processing apparatus according to claim 5 further comprising a user identifying module that identifies the user outputting an instruction to the process instruction receiving module; and
a user language storing module that stores languages corresponding to a plurality of users including the user,
wherein the language designation receiving module acquires the language, from the user language storing module, corresponding to the user identified by the user identifying module, and receives the acquired language as the language designation.

7. The information processing apparatus according to claim 1, wherein the storage module further stores sound output attribute information designating whether or not an audio guidance of the process state of the process instruction is output, to associate the sound attribute information with the process instruction, and
wherein the process state output module outputs the audio guidance when the information of the process state of the process instruction stored in the storage module is output and the sound output attribute information corresponding to the process instruction indicates that the information of the process state is to be output as the audio guidance.

8. The information processing apparatus according to claim further comprising audio guidance designation receiving module that receives an audio designation for designating whether or not the audio guidance is performed when the process instruction receiving module receives the process instruction from the user,
wherein the process state output module performs audio guidance with respect to an operation for receiving the process instruction when the audio guidance designation receiving module receives the audio designation designating that the audio guidance is to be performed,
wherein the storage module stores the sound output attribute information designating that the information of the process state of the process instruction is output by audio guidance, to associate the sound output attribute information with the process instruction, when it is designated that audio guidance is performed when the process instruction receiving module receives the process instruction.

9. The information processing apparatus according to claims 8 further comprising:
a user identifying module that identifies the user outputting an instruction to the process instruction receiving module; and
a user sound setting storing module that stores audio guidance setting information indicating whether or not an audio guidance is performed, to associate the audio guidance setting information with users including the user,
wherein the audio guidance designation receiving module acquires, from the user sound setting storing module, the audio guidance setting information corresponding to the user identified by the user identifying module, and receives the acquired setting information as the audio designation.

10. The information processing apparatus according to claim 1, wherein the process instruction receiving module receives the process instruction including the language attribute information, from an external apparatus, and
wherein the storage module stores the language attribute information to associate the language attribute information with the process instruction.

11. The information processing apparatus according to claim 1, wherein the storage module further stores a second process instruction and second language attribute information to associate with each other, the second language attribute information designating a second language for outputting a second process state of the second process instruction, and
the process state output module outputs a list screen displaying information of the process state of the process instruction in the language and information of a second process state of second process instruction in the second language.

12. The information processing apparatus according to claim further comprising change operation receiving module that displays an operation screen or performs audio guidance in the language designated by the language attribute information corresponding to the process instruction that is a target of a change operation, when the change operation of instruction contents regarding any one of a plurality of process instructions stored in the storage module is received.

13. A method for controlling an information processing apparatus, the method comprising:
receiving a process instruction from a user;
storing the process instruction and language attribute information to associate with each other, the language attribute information designating a language for outputting a process state of the process instruction; and
outputting information of the process state in the language designated by the language attribute information associated with the process instruction.

14. An information processing system comprising:
a process instruction receiving module that receives a process instruction from a user;
a storage module that stores the process instruction and language attribute information to associate with each other, the language attribute information designating a language for outputting a process state of the process instruction; and
a process state output module that outputs information of the process state in the language designated by the language attribute information associated with the process instruction.

15. An image forming apparatus comprising:
a process instruction receiving module that receives a process instruction from a user;
a storage module that stores the process instruction and language attribute information to associate with each other, the language attribute information designating a language for outputting a process state of the process instruction; and
a process state output module that outputs information of the process state in the language designated by the language attribute information associated with the process instruction.

16. An information processing system comprising:
an information processing apparatus; and
an external apparatus that outputs a process instruction to the information processing apparatus,
wherein the external apparatus includes a module that transmits language attribute information designating a language for outputting a process state of the process instruction to a user to be associated with the process instruction, and
wherein the information processing apparatus includes:
a storage module that stores the process instruction and the language attribute information to associate with each other; and
a process state output module that outputs the information of the process state in the language designated by the language attribute information associated with the process instruction.
